(19) United States
(12) Patent Application Publication
(10) Pub. No.: US 2025/0286972 A1
(43) Pub. Date: Sep. 11, 2025

(54) ELECTRONIC DEVICE CAPABLE OF SUPPRESSING SITUATION WHERE DISPLAY PORTION IS LIT DURING POWER-SAVING MODE

(71) Applicant: KYOCERA Document Solutions Inc., Osaka (JP)

(72) Inventor: XUAN THI HUONG VU, Osaka (JP)

(21) Appl. No.: 19/057,620

(22) Filed: Feb. 19, 2025

(30) Foreign Application Priority Data
Mar. 6, 2024 (JP) 2024-033613

(51) Int. Cl. H04N 1/00

(52) U.S. Cl. CPC H04N 1/00896; H04N 1/00408; H04N 1/0049; H04N 2201/0094

(57) ABSTRACT

An electronic device including a display portion, a first control portion, a second control portion, and a gate portion. Light of the display portion is turned off while the electronic device is operating in a power-saving mode. The first control portion outputs a first control signal when a user operation is accepted in an operation portion while the electronic device is operating in the power-saving mode. The second control portion outputs, in accordance with an input of the first control signal, a second control signal that instructs to light the display portion. The gate portion allows the second control signal to pass when the first control signal is output, and does not allow the second control signal to pass when the first control signal is not output.

### INCORPORATION BY REFERENCE

This application is based upon and claims the benefit of priority from the corresponding Japanese Patent Application No. 2024-033613 filed on Mar. 6, 2024, the entire contents of which are incorporated herein by reference.

### BACKGROUND

The present disclosure relates to an electronic device.

In an electronic device such as a multifunction peripheral, operations of respective portions of the electronic device are controlled by signals output from a main control portion including a CPU.

Further, there is known an electronic device capable of switching an operation mode between a normal mode and a power-saving mode in which power consumption is reduced as compared to the normal mode. In this type of electronic device, light of a display portion is turned off during operation in the power-saving mode. Also in this type of electronic device, when a user operation is accepted in an operation portion during operation in the power-saving mode, the operation mode is shifted from the power-saving mode to the normal mode, and the display portion is lit.

For example, in the electronic device, when a user operation is accepted in the operation portion during operation in the power-saving mode, a first control signal that indicates that the operation portion has been operated is output from a sub control portion which controls the display portion and the operation portion toward the main control portion. Also in the electronic device, a second control signal that instructs to light the display portion is output from the main control portion toward the sub control portion in accordance with an input of the first control signal to the main control portion.

### SUMMARY

An electronic device according to an aspect of the present disclosure is an electronic device capable of switching an operation mode between a normal mode and a power-saving mode in which power consumption is reduced as compared to the normal mode, and includes an operation portion, a display portion, a first control portion, a second control portion, and a gate portion. Light of the display portion is turned off while the electronic device is operating in the power-saving mode. The first control portion controls the operation portion and the display portion and outputs a first control signal when a user operation is accepted in the operation portion while the electronic device is operating in the power-saving mode. The second control portion outputs, in accordance with an input of the first control signal output from the first control portion, a second control signal that instructs to light the display portion toward the first control portion. The gate portion is provided on a transmission path of the second control signal, allows the second control signal to pass when the first control signal is output, and does not allow the second control signal to pass when the first control signal is not output.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a block diagram showing a system configuration of an image forming apparatus according to an embodiment of the present disclosure; and

FIG. 2 is a diagram showing a configuration of a main control portion, a sub control portion, and a gate portion in the image forming apparatus according to the embodiment of the present disclosure.

### DETAILED DESCRIPTION

Hereinafter, an embodiment of the present disclosure will be described with reference to the attached drawings. It is noted that the following embodiment is an example of embodying the present disclosure and does not limit the technical scope of the present disclosure.

### [Configuration of Image Forming Apparatus 100]

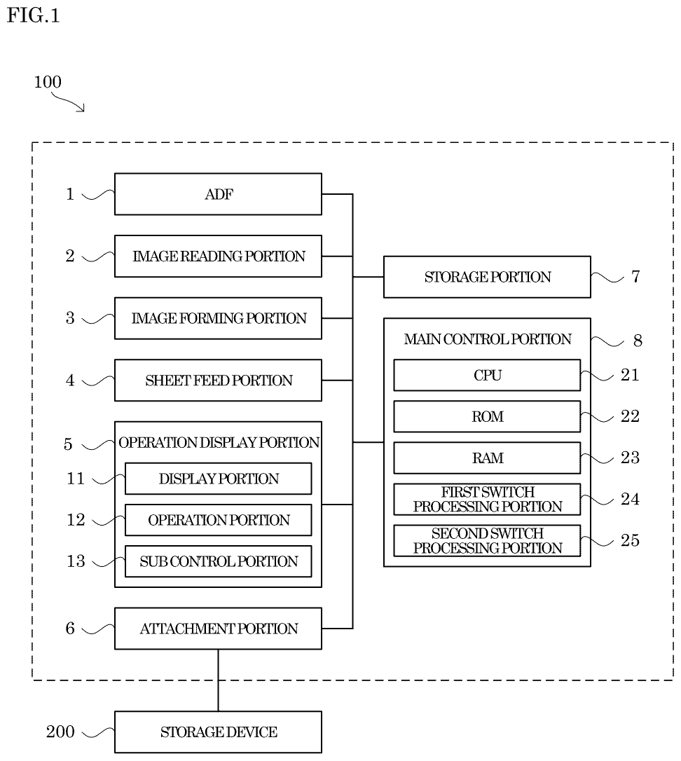

First, a configuration of an image forming apparatus 100 according to an embodiment of the present disclosure will be described with reference to FIG. 1. It is noted that in FIG. 1, the image forming apparatus 100 is indicated by a broken line.

The image forming apparatus 100 is a multifunction peripheral having a plurality of functions such as a facsimile function and a copying function along with a scanning function for reading an image of a document sheet and a print function for forming an image on a sheet based on image data. The image forming apparatus 100 is an example of an electronic device according to the present disclosure. It is noted that the present disclosure may also be applied to electronic devices such as a scanner, a printer, a facsimile apparatus, a copying machine, a personal computer, a laptop computer, a television, a microwave, and a refrigerator.

As shown in FIG. 1, the image forming apparatus 100 includes an ADF (Auto Document Feeder) 1, an image reading portion 2, an image forming portion 3, a sheet feed portion 4, an operation display portion 5, an attachment portion 6, a storage portion 7, and a main control portion 8.

The ADF 1 conveys a document sheet as a reading target of the scanning function. The ADF 1 includes a document sheet setting portion, a plurality of document sheet conveying rollers, a document sheet holder, and a sheet discharge portion.

The image reading portion 2 realizes the scanning function. The image reading portion 2 includes a document sheet table, a light source, a plurality of mirrors, an optical lens, and a CCD (Charge Coupled Device).

The image forming portion 3 realizes the print function. The image forming portion 3 includes a photoconductor drum, a charging roller, a laser scanning unit, a developing device, a toner container, a transfer roller, a cleaning device, a fixing device, and a sheet discharge tray.

The sheet feed portion 4 supplies sheets to the image forming portion 3. The sheet feed portion 4 includes a sheet feed cassette, a pickup roller, a sheet feed roller, a plurality of sheet conveying rollers, and a registration roller.

The operation display portion 5 is a user interface of the image forming apparatus 100. As shown in FIG. 1, the operation display portion 5 includes a display portion 11, an operation portion 12, and a sub control portion 13. The display portion 11 is used to display information to a user. For example, the display portion 11 is a flat panel display such as a liquid crystal display. The operation portion 12 is used by the user to input information to the image forming apparatus 100. For example, the operation portion 12 includes an operation key and a touch panel. The sub control portion 13 controls the display portion 11 and the operation portion 12. The sub control portion 13 is constituted of an electronic circuit such as an integrated circuit (ASIC, DSP).

The attachment portion 6 includes a USB connection terminal to/from which an external electronic device capable of inputting and outputting data based on a USB standard is attached/detached. For example, a storage device 200 (see FIG. 1) capable of writing and reading data based on the USB standard is attached/detached to/from the attachment portion 6. For example, the storage device 200 is a USB memory.

The storage portion 7 is a nonvolatile storage device. For example, the storage portion 7 is a storage device such as a nonvolatile memory including a flash memory and the like, an SSD (Solid State Drive), and an HDD (Hard Disk Drive).

The main control portion 8 collectively controls the image forming apparatus 100. As shown in FIG. 1, the main control portion 8 includes a CPU 21, a ROM 22, and a RAM 23. The CPU 21 is a processor which executes various types of arithmetic processing. The ROM 22 is a nonvolatile storage device in which information such as control programs for causing the CPU 21 to execute various types of processing is stored in advance. The RAM 23 is a volatile or nonvolatile storage device that is used as a temporary storage memory (working area) for the various types of processing to be executed by the CPU 21. The CPU 21 executes the various control programs stored in advance in the ROM 22 to collectively control the image forming apparatus 100.

Further, the main control portion 8 is capable of switching an operation mode of the image forming apparatus 100 between a normal mode and a power-saving mode in which power consumption is reduced as compared to the normal mode. Light of the display portion 11 is turned off while the image forming apparatus 100 is operating in the power-saving mode.

For example, when the operation mode of the image forming apparatus 100 is the normal mode and a non-operation state where the image forming apparatus 100 is not operated continues for a predetermined time or a predetermined operation is made in the operation portion 12, the main control portion 8 shifts the operation mode from the normal mode to the power-saving mode. In addition, when the operation mode of the image forming apparatus 100 is the power-saving mode and a user operation is accepted in the operation portion 12, the main control portion 8 shifts the operation mode from the power-saving mode to the normal mode.

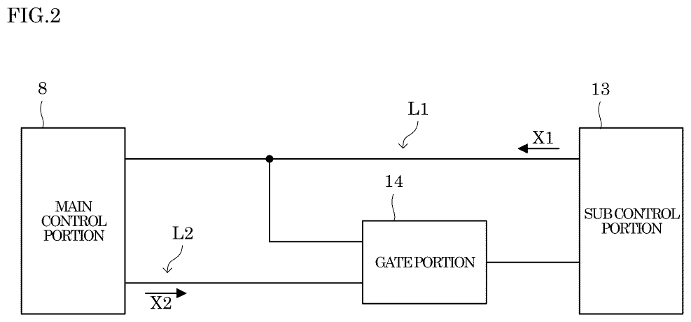

For example, in the image forming apparatus 100, the main control portion 8 and the sub control portion 13 are connected by signal lines L1 and L2 shown in FIG. 2. The signal line L1 is used to transmit a first control signal X1 (see FIG. 2) that is output from the sub control portion 13 toward the main control portion 8 and indicates that the operation portion 12 has been operated. The signal line L2 is used to transmit a second control signal X2 (see FIG. 2) that is output from the main control portion 8 toward the sub control portion 13 and instructs to light the display portion 11.

Further, the sub control portion 13 outputs the first control signal X1 when a user operation is accepted in the operation portion 12 while the image forming apparatus 100 is operating in the power-saving mode. For example, the first control signal X1 is a signal that is output by switching a voltage of the signal line L1 from a high level to a low level. The sub control portion 13 is an example of a first control portion according to the present disclosure.

Further, the main control portion 8 outputs the second control signal X2 that instructs to light the display portion 11 toward the sub control portion 13 in accordance with an input of the first control signal X1 output from the sub control portion 13. For example, the second control signal X2 is a signal that is output by switching a voltage of the signal line L2 from a high level to a low level. The main control portion 8 is an example of a second control portion according to the present disclosure.

Furthermore, in accordance with an input of the second control signal X2 output from the main control portion 8, the sub control portion 13 lights the display portion 11 and causes the display portion 11 to display an operation screen used for operating the image forming apparatus 100, or the like.

Incidentally, in the image forming apparatus 100, noises may enter the signal line L2 (see FIG. 2), and the display portion 11 may be lit irrespective of the fact that the operation mode is the power-saving mode. For example, in the image forming apparatus 100, when attaching the storage device 200 to the attachment portion 6, electrostatic discharge may be caused between fingers of the user and the attachment portion 6. If the electrostatic discharge is caused while the image forming apparatus 100 is operating in the power-saving mode, high-frequency signals (noises) due to the electrostatic discharge may enter the signal line L2, and thus the sub control portion 13 may misrecognize that the second control signal X2 has been input.

In contrast, in the image forming apparatus 100 according to the embodiment of the present disclosure, it is possible to suppress a situation where the display portion 11 is lit during the power-saving mode as will be described below.

Specifically, the operation display portion 5 includes a gate portion 14 shown in FIG. 2.

The gate portion 14 is provided on the signal line L2 as a transmission path of the second control signal X2. For example, the gate portion 14 is provided on a sub control substrate on which the sub control portion 13 is mounted. It is noted that the sub control substrate is connected to a main control substrate on which the respective constituent elements of the main control portion 8 are mounted via a harness. The signal line L2 extends from the CPU 21 to the sub control portion 13 via print wiring formed on the main control substrate, the harness, and print wiring formed on the sub control substrate.

The gate portion 14 allows the second control signal X2 to pass when the first control signal X1 is output, and does not allow the second control signal X2 to pass when the first control signal X1 is not output.

For example, the gate portion 14 is an OR gate including a first input terminal connected to the signal line L1, a second input terminal connected to the signal line L2, and an output terminal. Thus, even when high-frequency signals (noises) enter the signal line L2 in the harness and the voltage of the signal line L2 is instantaneously switched to the low level, as long as the voltage of the signal line L1 is of a high level (as long as the first control signal X1 is not output), a voltage of an input terminal of the sub control portion 13 to which the second control signal X2 is input is maintained at a high level.

It is noted that the gate portion 14 may include a NOR gate whose output terminal is connected to an input terminal of a NOT gate in place of the OR gate.

Alternatively, the first control signal X1 may be a signal that is output by switching the voltage of the signal line L1 from the low level to the high level, and the second control signal X2 may be a signal that is output by switching the voltage of the signal line L2 from the low level to the high level. In this case, the gate portion 14 only needs to be an AND gate including a first input terminal connected to the signal line L1, a second input terminal connected to the signal line L2, and an output terminal.

Alternatively, the first control signal X1 may be a signal that is output by switching the voltage of the signal line L1 from the high level to the low level, and the second control signal X2 may be a signal that is output by switching the voltage of the signal line L2 from the low level to the high level. In this case, the gate portion 14 only needs to include an AND gate including a first input terminal connected to the signal line L1 via a NOT gate, a second input terminal connected to the signal line L2, and an output terminal.

Alternatively, the first control signal X1 may be a signal that is output by switching the voltage of the signal line L1 from the low level to the high level, and the second control signal X2 may be a signal that is output by switching the voltage of the signal line L2 from the high level to the low level. In this case, the gate portion 14 only needs to include an OR gate including a first input terminal connected to the signal line L1 via a NOT gate, a second input terminal connected to the signal line L2, and an output terminal.

In this manner, in the image forming apparatus 100, the gate portion 14 that allows the second control signal X2 to pass when the first control signal X1 is output and does not allow the second control signal X2 to pass when the first control signal X1 is not output is provided on the signal line L2. Thus, it is possible to suppress a situation where the display portion 11 is lit during the power-saving mode due to noises entering the signal line L2.

### Notes of Disclosure

Hereinafter, a general outline of the invention extracted from the embodiment described above will be noted. It is noted that the respective configurations and processing functions described in the notes below can be sorted and arbitrarily combined as appropriate.

### <Note 1>

An electronic device capable of switching an operation mode between a normal mode and a power-saving mode in which power consumption is reduced as compared to the normal mode, including: an operation portion; a display portion whose light is turned off while the electronic device is operating in the power-saving mode; a first control portion which controls the operation portion and the display portion and outputs a first control signal when a user operation is accepted in the operation portion while the electronic device is operating in the power-saving mode; a second control portion which outputs, in accordance with an input of the first control signal output from the first control portion, a second control signal that instructs to light the display portion toward the first control portion; and a gate portion which is provided on a transmission path of the second control signal, allows the second control signal to pass when the first control signal is output, and does not allow the second control signal to pass when the first control signal is not output.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An electronic device capable of switching an operation mode between a normal mode and a power-saving mode in which power consumption is reduced as compared to the normal mode, comprising:
an operation portion;
a display portion whose light is turned off while the electronic device is operating in the power-saving mode;
a first control portion which controls the operation portion and the display portion and outputs a first control signal when a user operation is accepted in the operation portion while the electronic device is operating in the power-saving mode;
a second control portion which outputs, in accordance with an input of the first control signal output from the first control portion, a second control signal that instructs to light the display portion toward the first control portion; and
a gate portion which is provided on a transmission path of the second control signal, allows the second control signal to pass when the first control signal is output, and does not allow the second control signal to pass when the first control signal is not output.
